(19) United States
(12) Patent Application Publication
(10) Pub. No.: US 2006/0236016 A1
(43) Pub. Date: Oct. 19, 2006

(54) Method, system, and apparatus to support device configuration

(76) Inventor: R. Scott Tetrick, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/109,897

(22) Filed: Apr. 19, 2005

(51) Int. Cl. G06F 13/36

(52) U.S. Cl. 710/306

(57) ABSTRACT

A technique is discussed for representing cores and threads of a multi-core processor as a virtual device with a bridge device with the functionality of a PCI bridge device with an ability to direct configuration accesses to a memory image of the virtual device. The bridge device may be incorporated within an IOH and supports a PCI configuration header with a capability point, to direct configuration accesses to a memory image of the virtual device.

### BACKGROUND OF THE INVENTION

1. Field of the Invention

The present invention relates to supporting device configuration, specifically, configuration space redirection for virtual devices.

2. Description of the Related Art

Recently, there is an advent of multiple cores and multiple threads for computer systems. Consequently, utilization of cores to represent devices has proliferated. However, present processors cannot be identified as a device because they have no provisions for Peripheral Component Interconnect (PCI) configuration space. Therefore, a need exists for adding a device configuration to a computer system in an extensible manner.

### BRIEF DESCRIPTION OF THE SEVERAL VIEWS OF THE DRAWINGS

Subject matter is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is an apparatus for a bridge as utilized by one embodiment of the claimed subject matter.

FIG. 2 is a capability pointer as utilized by one embodiment of the claimed subject matter.

FIG. 3 is a PCI hierarchy and configuration space as utilized by one embodiment of the claimed subject matter.

FIG. 4 is an address calculation for configuration access as utilized by one embodiment of the claimed subject matter.

### DETAILED DESCRIPTION OF THE INVENTION

In the following description, for purposes of explanation, numerous details are set forth in order to provide a thorough understanding of the present invention. However, it will be apparent to one skilled in the art that these specific details are not required in order to practice the present invention.

An area of current technological development relates to improving utilization of multiple cores and multiple threads. As previously described, present processors cannot be identified as a device because they have no provisions for PCI configuration space. Therefore, a need exists for adding a device configuration to a computer system in an extensible manner. In contrast, a method, apparatus, and system that facilitates adding a single device in an Input/Output Hub (IOH) as a bridge. In one embodiment the claimed subject matter teaches a bridge and method for facilitates access to actual and virtual devices based at least in part on a hierarchy of virtual devices connected to a bus via the bridge and accessed based at least in part on a configuration header and capability pointer to a configure space in a memory image.

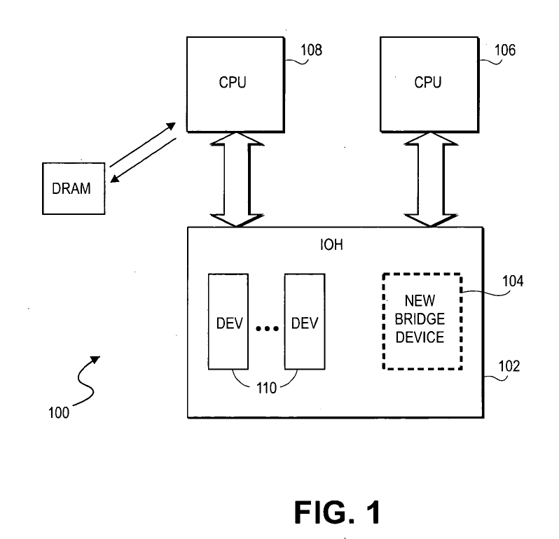

FIG. 1 is an apparatus for a bridge as utilized by one embodiment of the claimed subject matter. In this embodiment, an IOH 104 is communicating with multiple CPUs 106 and 108, wherein the multiple CPUs support multiple cores and multiple threads. Hence, each core may be represented as a device, depicted as “Dev” 110. As previously, utilization of cores to represent devices has proliferated. For example, a processor could be identified as an MPEG Encoder/Decoder for continuous media operations, or a TOE (TCP/IP over Ethernet) accelerator for network processing.

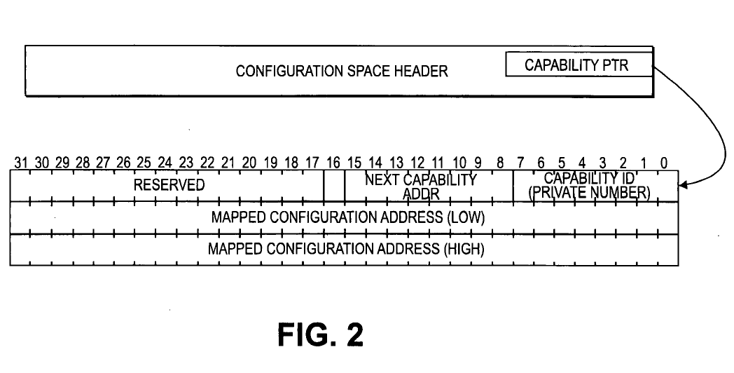

An additional device in the IOH, new bridge device 104, is utilized. This new bridge device is a normal PCI bridge device, with a special purpose capability for directing configuration accesses to a memory image of the virtual devices. An example is discussed in further detail in connection with FIG. 2.

FIG. 2 is a capability pointer as utilized by one embodiment of the claimed subject matter. In this embodiment, a configuration space header has a field designated as a capability pointer. The mapped configuration address refers a memory mapped address for the configuration space of the virtual devices. In this embodiment, there is another set of configuration registers used for interrupts (which is discussed later) in addition to the feature of configuration address to refer a memory mapped address for the configuration space of the virtual devices. In another embodiment, the configuration registers used for interrupts is provided separately from the memory mapped address for configuration space of the virtual devices.

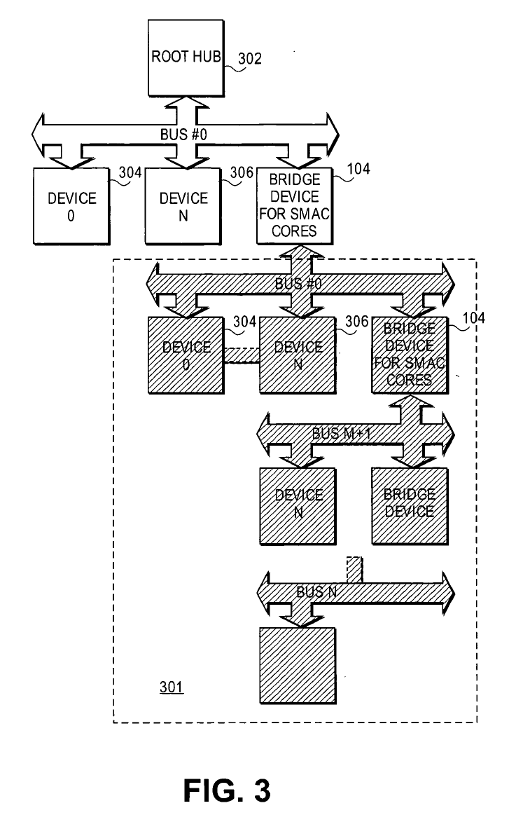

FIG. 3 is a PCI hierarchy and configuration space as utilized by one embodiment of the claimed subject matter. In this embodiment, the bridge device 104 that was discussed earlier in connection with FIG. 1 facilitates mapping additional buses and virtual devices (everything within shaded devices 301) into a PCI hierarchy depicted in this figure. In this embodiment, the additional buses and virtual devices are depicted as shaded devices. In this embodiment, a primary bus number, bus 0, is coupled to a Root Hub 202, device 0 (304), device n (306) and the bridge device 104. The secondary bus number, bus M, and the subordinate bus number, bus N, and all buses from M to N inclusive, such as bus M+1, are mapped below this bridge in the hierarchy. As previously discussed, the devices and buses in the shaded device cloud 301 do not exist in the system, but their configuration spaces do. Thus, any access to a device's configuration space behind the bridge is directed to memory via the configuration space for the PCI configuration header and special capability pointer.

The memory image column with a memory space and configuration spaces represent the virtual devices. As previously discussed, the shaded devices in cloud 301 are virtual devices and do not really exist in a system. However, their configuration spaces do exist in the configuration space represented in memory. In one embodiment, the configuration spaces are 4K bytes and are accessed based on a capability pointer and are uniquely mapped, a one to one mapping from a virtual device to a specific configuration space. Therefore, any access to a virtual device's configuration space that is behind the bridge (in cloud 301) is directed to memory.

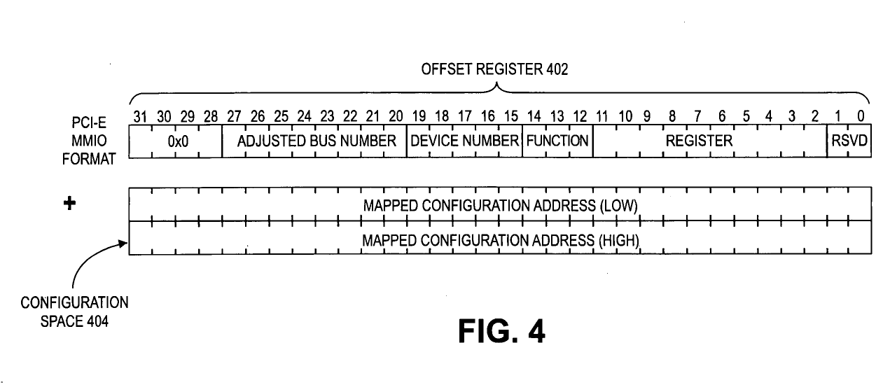

FIG. 4 is an address calculation for configuration access as utilized by one embodiment of the claimed subject matter. In this figure, an offset register 402 is used to calculate the next address for another configuration space of a virtual device. In one embodiment, the offset register has a value equivalent to 4 k bytes to allow a configuration space size of 4 k bytes. In this embodiment, a configuration space 404 is accessed. For another access, the value of the offset register is added to the configuration space to jump to the next 4 k byte configuration space.

In this embodiment, the offset register 402 would have values for a device number, adjusted bus number, and a function.

As previously discussed, the BIOS could be used for initialization of memory space and for the bridge handling configuration space accesses as utilized by one embodiment of the claimed subject matter. In order to facilitate the bridge device 104 handling the configuration space accesses, in one embodiment, the BIOS is responsible for initializing the memory space and the bridge device. In this embodiment, the BIOS supports the header information, discussed in connection with FIG. 2, and any additional configuration space required. The BIOS is also expected to set an interrupt capability for a CPU. The image in memory is the current read information. Any read to the configuration space is just directed to the appropriate memory location, and the value is read. Read side effects of configuration accesses are not supported.

Therefore, the BIOS has set all values. Subsequently, the bridge device 104 is responsible for the configuration space accesses. If the operation is a read, the IOH reads the appropriate memory location and returns that value as that of the configuration access. If the operation is a configuration write, an interrupt is generated (mentioned above) to the CPU, with address and data locations to be specified. The CPU receives the interrupt, and updates the configuration space appropriately based on the address and data information. When the configuration space is correctly updated, the CPU writes a completion register (IOH defined), and the write operation is completed.

Although the claimed subject matter has been described with reference to specific embodiments, this description is not meant to be construed in a limiting sense. Various modifications of the disclosed embodiment, as well as alternative embodiments of the claimed subject matter, will become apparent to persons skilled in the art upon reference to the description of the claimed subject matter. It is contemplated, therefore, that such modifications can be made without departing from the spirit or scope of the claimed subject matter as defined in the appended claims.

1. An apparatus to allow a core of a multi-core processor to be represented as a virtual device comprising:
a configuration space header with a field designated as a capability pointer; and
a mapped configuration address to refer a memory mapped address for the configuration space of the virtual device.

2. The apparatus of claim 1 wherein the capability pointer identifies a capability ID that is a private number.

3. The apparatus of claim 1 wherein the apparatus is a bridge device is a PCI bridge device, incorporated within an IOH, with the ability to direct configuration accesses to a memory image of the virtual device.

4. An apparatus to allow a core of a multi-core processor to be represented as a virtual device comprising:
a bridge device with the functionality of a PCI bridge device, incorporated within an IOH, and an ability to direct configuration accesses to a memory image of the virtual device.

5. The apparatus of claim 4 further comprising:
a configuration space header with a field designated as a capability pointer; and
a mapped configuration address to refer a memory mapped address for the configuration space of the virtual device.

6. The apparatus of claim 5 wherein the capability pointer identifies a capability ID that is a private number.

7. An apparatus to allow a core of a multi-core processor to be represented as a virtual device comprising:
a configuration space header with a field designated as a capability pointer; and
a mapped configuration address to refer a memory mapped address for the configuration space of the virtual device; and
a bridge device with the functionality of a PCI bridge device, incorporated within an IOH, and an ability to direct configuration accesses to a memory image of the virtual device.

8. The apparatus of claim 7 wherein the capability pointer identifies a capability ID that is a private number.

9. An apparatus to define a PCI hierarchy to represent a core as a virtual device comprising:
a bridge device to define a plurality of virtual devices coupled to virtual busses, the bridge device is coupled to a primary PCI bus that is connected to actual discrete computing devices;
the bridge device with the functionality of a PCI bridge device, incorporated within an IOH, and an ability to direct configuration accesses to a memory image of the virtual device; and
the virtual devices that are defined by the bridge device do not exist in a computing system, nonetheless, a respective configuration space for the virtual devices do exist.

10. The apparatus of claim 9 wherein the bridge device is incorporated within an IOH.

11. The apparatus of claim 9 wherein the virtual busses are mapped below the bridge device.

12. The apparatus of claim 9 wherein the bridge device utilizes a PCI configuration header with a capability point, to direct configuration accesses to a memory image of the virtual device.

13. An apparatus to define a PCI hierarchy to represent a core as a virtual device comprising:
a bridge device to define a plurality of virtual devices coupled to virtual busses, the bridge device is coupled to a primary PCI bus that is connected to actual discrete computing devices;
the bridge device with the functionality of a PCI bridge device, incorporated within an IOH, and an ability to direct configuration accesses to a memory image of the virtual device;
the virtual devices that are defined by the bridge device do not exist in a computing system, nonetheless, a respective configuration space for the virtual devices do exist; and
wherein the bridge device utilizes a PCI configuration header with a capability point, to direct configuration accesses to a memory image of the virtual device

14. The apparatus of claim 13 wherein the bridge device is incorporated within an IOH.

15. The apparatus of claim 13 wherein the virtual busses are mapped below the bridge device.

16. A method for representing a core as a virtual device comprising:
storing a configuration space for the virtual device with a PCI configuration header; and
performing an address calculation based at least in part on the configuration space of the virtual device

17. The method of claim 16 wherein the PCI configuration header stores a capability pointer.

18. An article of manufacture comprising:
a machine-readable medium having a plurality of machine readable instructions, wherein when the instructions are executed by a system, the instructions provide to allow a core of a multi-core processor to be represented as a virtual for:
initializing a memory space and a bridge device, the bridge device has a functionality of a PCI bridge device, and an ability to direct configuration accesses to a memory image of the virtual device;
supporting a capability pointer in a PCI configuration space header; and
setting an interrupt capability for the multi-core processor.

19. The article of manufacture of claim 18 wherein the bridge device is incorporated within an IOH

20. An article of manufacture comprising:
a machine-readable medium having a plurality of machine readable instructions, wherein when the instructions are executed by a system, the instructions provide to allow a core of a multi-core processor to be represented as a virtual for:
initializing a memory space and a bridge device, the bridge device has a functionality of a PCI bridge device, and an ability to direct configuration accesses to a memory image of the virtual device; and
supporting a capability pointer in a PCI configuration space header.

21. The article of manufacture of claim 20 wherein the bridge device is incorporated within an IOH.

22. A system to support at least one multi-core processor comprising:
a dynamic random access memory, coupled to the multi-core processor;
a bridge device, a bridge device with the functionality of a PCI bridge device with an ability to direct configuration accesses to a memory image of the virtual device.

23. The system of claim 22 wherein the bridge device is incorporated within an IOH.

24. A system to support at least one multi-core processor comprising:
a dynamic random access memory, coupled to the multi-core processor; and
a bridge device to define a plurality of virtual devices coupled to virtual busses, the bridge device is coupled to a primary PCI bus that is connected to actual discrete computing devices;
the bridge device with the functionality of a PCI bridge device, incorporated within an IOH, and an ability to direct configuration accesses to a memory image of the virtual device;
the virtual devices that are defined by the bridge device do not exist in a computing system, nonetheless, a respective configuration space for the virtual devices do exist; and
wherein the bridge device utilizes a PCI configuration header with a capability point, to direct configuration accesses to a memory image of the virtual device.

25. The system of claim 24 wherein the bridge device is incorporated within an IOH.
